(19) United States
(12) Patent Application Publication
(10) Pub. No.: US 2025/0385307 A1
(43) Pub. Date: Dec. 18, 2025

(54) LITHIUM-ION BATTERY

(71) Applicant: SHENZHEN CAPCHEM TECHNOLOGY CO., LTD., Shenzhen, Guangdong (CN)

(72) Inventors: Yunxian Qian, Shenzhen, Guangdong (CN); Shiguang Hu, Shenzhen, Guangdong (CN); Yong Wang, Shenzhen, Guangdong (CN); Xiaoxia Xiang, Shenzhen, Guangdong (CN)

(21) Appl. No.: 18/878,644

(22) PCT Filed: Jun. 27, 2023
(86) PCT No.: PCT/CN2023/102556

§ 371 Date: Dec. 23, 2024

(30) Foreign Application Priority Data
Aug. 18, 2022 (CN) 202210990069.8

(51) Int. Cl. H01M 10/0567; H01M 4/02; H01M 4/131; H01M 4/525; H01M 10/0525; H01M 10/0569

(52) U.S. Cl. CPC H01M 10/0567; H01M 4/131; H01M 4/525; H01M 10/0525; H01M 10/0569; H01M 2004/021; H01M 2004/028; H01M 2300/0028

(57) ABSTRACT

A lithium-ion battery, including a positive electrode, a negative electrode and a non-aqueous electrolyte. The positive electrode includes a positive electrode material layer containing a lithium cobalt oxide, the negative electrode includes a negative electrode current collector and a negative electrode material layer formed on the negative electrode current collector, the negative electrode material layer includes a negative electrode active material, and the non-aqueous electrolyte includes a non-aqueous organic solvent, a lithium salt and an additive. The non-aqueous organic solvent includes a carboxylic ester. The lithium-ion battery provided by the application has good performance under high temperature and low temperature conditions.

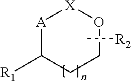

### TECHNICAL FIELD

The application belongs to the technical field of energy storage devices, and particularly relates to a lithium-ion battery.

### BACKGROUND

Lithium-ion batteries have been widely used in 3 C digital products such as mobile phones, notebook computers and new energy vehicles because of their high working voltage, wide working temperature range, high energy density and power density, no memory effect and long cycle life. In recent years, with the continuous development of thin and light 3 C digital products, the battery industry increasingly requires lithium-ion batteries with high energy density.

Currently, there are two basic approaches for increasing the energy density of batteries. One is to increase the positive electrode's cut-off voltage, while the other is to pressurize the electrode's active material layer in order to obtain high density. However, increasing the charging cut-off voltage of the positive electrode improves its activity and intensifies the side reaction between the positive electrode and the electrolyte, which leads to the dissolution of the positive electrode's transition metal ions, deteriorating the battery's high-temperature performance. Furthermore, using an electrode with high compaction density might increase the load on the electrode plate, resulting in a higher total energy density for the battery. However, the low porosity of the electrode with high compaction density reduces the battery's liquid retention capacity, making it difficult for electrolyte to penetrate at the interface of the low-porosity electrode plate, increasing the contact internal resistance between the electrolyte and electrode. In the long-term cycle process, the polarization of charge and discharge will increase, resulting in sharp capacity loss due to lithium precipitation. Moreover, the lithium-ion conduction channel of the electrode with high compaction density piece is tortuous, making lithium ion transmission problematic, resulting in poor battery performance at low temperatures. To summarize, the prior art method of improving energy density will make it impossible to realize both the high and low temperatures of the battery, resulting in poor high-temperature cycle performance. As a result, how to achieve both high and low-temperature performance, as well as strong fast-charging performance for lithium-ion batteries with high-voltage and high compaction density, is an industry problem that must be addressed from a variety of perspectives, including electrode materials and electrolyte. From the point of view of electrolyte, in the prior art, a carboxylic ester system with high dielectric constant and low viscosity is often adopted as a solvent to improve the low-temperature and fast-charging performance of the battery. However, the carboxylic ester is unstable at high voltage, and it is likely to generate decomposition products at the positive electrode, and the decomposition products will be reduced when they migrate to the negative electrode, resulting in the loss of active Li and the increase of battery impedance, thus deteriorating the capacity after storage and being difficult to meet the demand.

### SUMMARY OF THE INVENTION

To address the issue that it is difficult to ensure both high and low-temperature performances for the existing lithium-ion batteries with high-voltage and high compaction density, the application provides a lithium-ion battery.

The technical solutions adopted by the application to solve the technical problems are as follows.

The application provides a lithium-ion battery, including a positive electrode, a negative electrode and a non-aqueous electrolyte, and the positive electrode includes a positive electrode material layer, the positive electrode material layer includes a positive electrode active material containing a lithium cobalt oxide, the negative electrode includes a negative electrode current collector and a negative electrode material layer formed on the negative electrode current collector, the negative electrode material layer includes a negative electrode active material, the non-aqueous electrolyte includes a non-aqueous organic solvent, a lithium salt and an additive, and the non-aqueous organic solvent includes a carboxylic ester, and the additive includes a compound represented by structural formula 1:

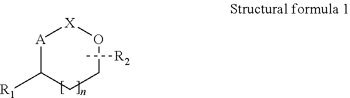

n is 0 or 1, A is selected from C or O, X is selected from

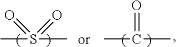

R₁ and R₂ are independently selected from H,

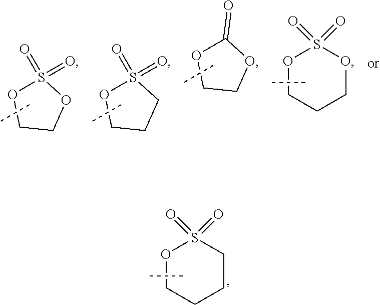

R₁ and R₂ are not selected from H at the same time, and X, R₁ and R₂ contain at least one sulfur atom;
the lithium-ion battery meets the following requirements:
1.5≤m/(n*a)≤600, and 0.05≤m≤5, 0.006≤n≤0.02, 0.6≤a≤2;
and m is a percentage mass content of the compound represented by structural formula 1 in the non-aqueous electrolyte, in %;
n is a mass of the single-sided negative electrode material layer on the negative electrode per unit area, in g/cm²; and
a is a specific surface area of the negative electrode active material, in m²/g.

Alternatively, the percentage mass content of the carboxylic ester is 10%-55% based on the total mass of the non-aqueous electrolyte.

Alternatively, the lithium-ion battery meets the following requirements:
5≤m/(n*a)≤300.

Alternatively, the percentage mass content (m) of the compound represented by structural formula 1 in the non-aqueous electrolyte is 0.1%-3%.

Alternatively, the mass of the single-sided negative electrode material layer (n) on the negative electrode per unit area is 0.008-0.015 g/cm².

Alternatively, the specific surface area (a) of the negative electrode active material is 0.7-1.6 m²/g.

Alternatively, the compound represented by structural formula 1 is selected from one or more of the following compounds:

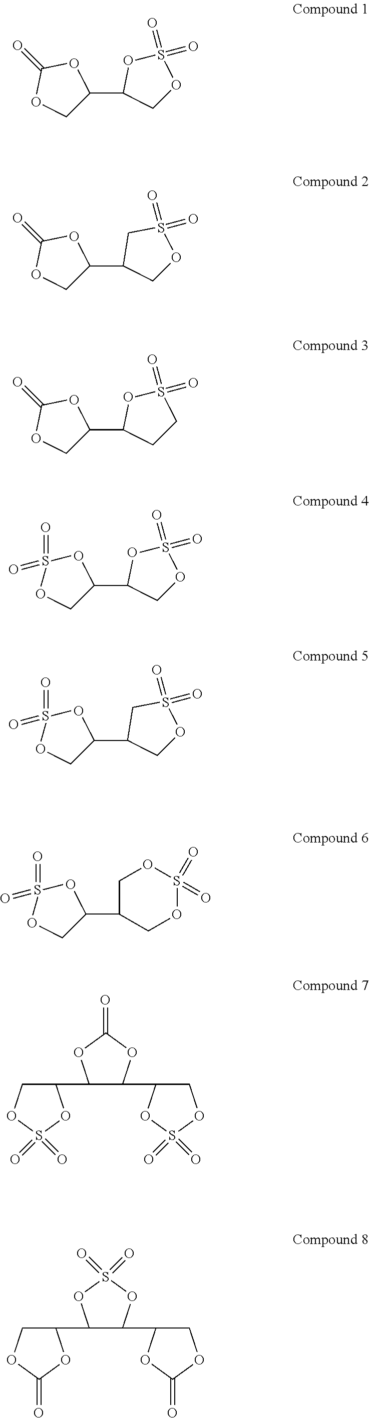

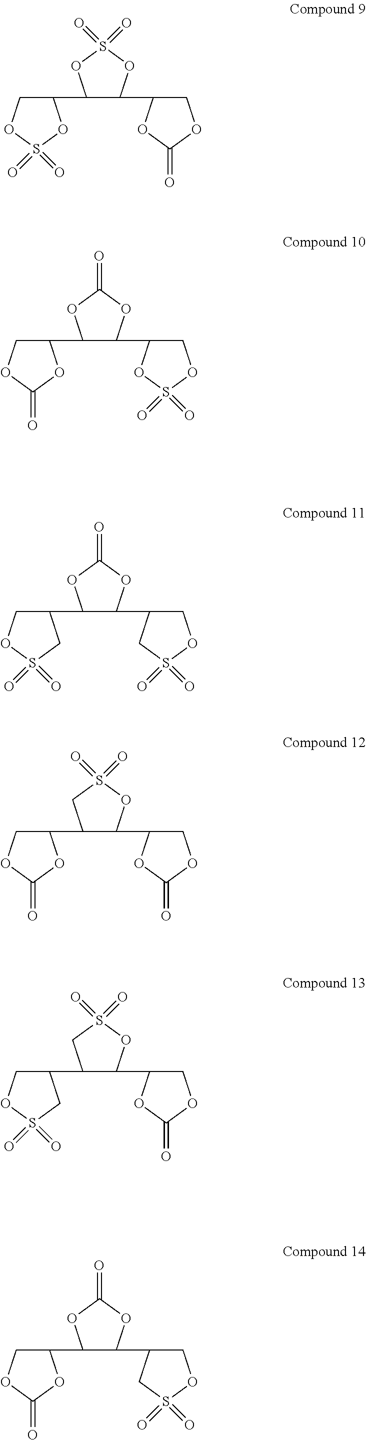 [SMILES: O=C1OCC(C2OS(=O)(=O)OC2C2COS(=O)(=O)O2)O1 ; O=C1OCC(C2OC(=O)OC2C2COS(=O)(=O)O2)O1 ; O=C1OC(C2COS(=O)(=O)C2)C(C2COS(=O)(=O)C2)O1 ; O=C1OCC(C2CS(=O)(=O)OC2C2COC(=O)O2)O1 ; O=C1OCC(C2OS(=O)(=O)CC2C2COS(=O)(=O)C2)O1 ; O=C1OCC(C2OC(=O)OC2C2COS(=O)(=O)C2)O1]

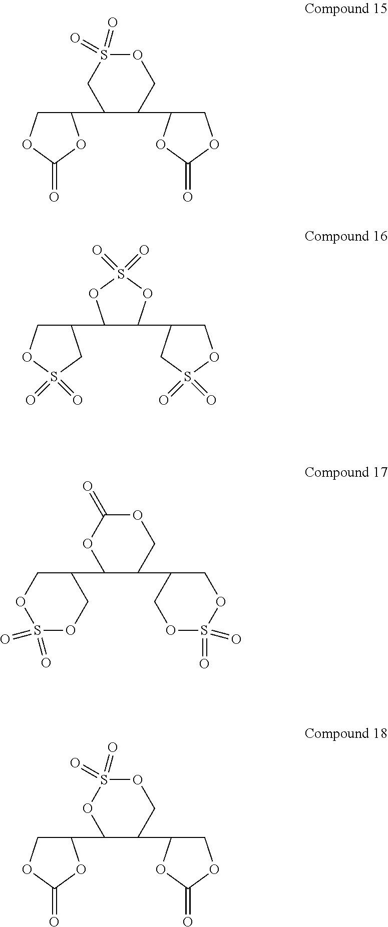 [SMILES: O=C1OCC(C2COS(=O)(=O)CC2C2COC(=O)O2)O1 ; O=S1(=O)CC(C2OS(=O)(=O)OC2C2COS(=O)(=O)C2)CO1 ; O=C1OCC(C2COS(=O)(=O)OC2)C(C2COS(=O)(=O)OC2)O1 ; O=C1OCC(C2COS(=O)(=O)OC2C2COC(=O)O2)O1]

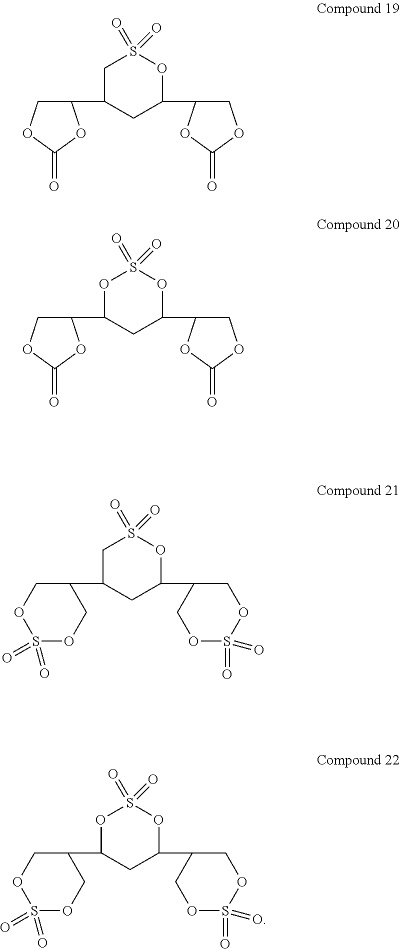 [SMILES: O=C1OCC(C2CC(C3COC(=O)O3)OS(=O)(=O)C2)O1 ; O=C1OCC(C2CC(C3COC(=O)O3)OS(=O)(=O)O2)O1 ; O=S1(=O)CC(C2COS(=O)(=O)OC2)CC(C2COS(=O)(=O)OC2)O1 ; O=S1(=O)OCC(C2CC(C3COS(=O)(=O)OC3)OS(=O)(=O)O2)CO1]

Alternatively, the carboxylic ester includes a cyclic carboxylic ester and/or a chain carbonate.

Alternatively, the additive further includes at least one of cyclic sulfate compounds, sultone compounds, cyclic carbonate compounds, phosphate compounds, borate compounds and nitrile compounds; and
the content of the additive is 0.01%-30% based on the total mass of the non-aqueous electrolyte being 100%.

Alternatively, the cyclic sulfate compound is selected from at least one of ethylene sulfate, propylene sulfate, methyl ethylene sulfate,

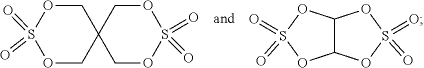 [SMILES: O=S1(=O)OCC2(CO1)COS(=O)(=O)OC2 ; O=S1(=O)OC2OS(=O)(=O)OC2O1]

the sultone compound is at least one selected from the group consisting of 1,3-propane sultone, 1,4-butane sultone and 1,3-propylene sultone;
the cyclic carbonate compound is selected from at least one of vinylene carbonate, vinylethylene carbonate, methylene ethylene carbonate, fluoroethylene carbonate, trifluoromethyl ethylene carbonate, bis-fluoroethylene carbonate or a compound represented by structural formula 2.

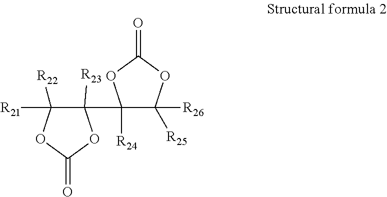

in structural formula 2, R₂₁, R₂₂, R₂₃, R₂₄, R₂₅ and R₂₆ are independently selected from one of a hydrogen atom, a halogen atom and a C1-C5 group;
the phosphate compound is selected from at least one of tri (trimethylsilane) phosphate, tri (trimethylsilane) phosphite or a compound represented by structural formula 3:

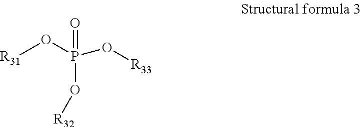

in structural formula 3, R₃₁, R₃₂ and R₃₃ are independently selected from a C1-C5 saturated hydrocarbon group, an unsaturated hydrocarbon group, a halogenated hydrocarbon group and —Si(CₘH₂ₘ₊₁)₃, m is a natural number of 1-3, and at least one of R₃₁, R₃₂ and R₃₃ is unsaturated hydrocarbon group;
the borate compound is selected from at least one of tris (trimethylsilane) borate and tris (triethyl silicane) borate; and
the nitrile compound is selected from one or more of butanedinitrile, glutaronitrile, ethylene glycol bis (propionitrile) ether, hexanetricarbonitrile, adiponitrile, pimelic dinitrile, hexamethylene dicyanide, azelaic dinitrile and sebaconitrile.

According to the lithium-ion battery provided by the application, lithium cobalt oxide is used as the positive electrode active material, allowing the lithium-ion battery to have higher energy density and higher working voltage. Through a lot of innovative research, the inventor found that by adding the compound represented by structural formula 1 as an additive in the non-aqueous electrolyte containing carboxylic ester solvent, and managing the relationship of the percentage mass content (m) of the compound represented by structural formula 1 in the non-aqueous electrolyte, the mass of the single-sided negative electrode material layer (n) on the negative electrode per unit area and the specific surface area (a) of the negative electrode active material, the low and high temperature performances can be balanced for lithium ion batteries with high voltage and high compaction density. The reason is that the compound represented by structural formula 1 participates in the film formation on the surface of the negative electrode, and the surface of the negative electrode is the main place where the compound represented by structural formula 1 plays its role, so the reaction area of the negative electrode has a great influence on the action effect of the additive, and the negative electrode reaction area is directly related to the mass of the single-sided negative electrode material layer (n) on the negative electrode per unit area and the specific surface area (a) of the negative electrode active material. If the reaction area of the negative electrode is small, the additive film is too thick in the negative electrode region, which can improve the reduction of carboxylate oxidation products at the negative electrode, but it causes high basic impedance, which is not conducive to the low temperature performance of the battery. If the reaction area of the negative electrode is too large, the additive film can not completely cover the negative electrode, and the reduction of carboxylate oxidation products at the negative electrode can not be effectively inhibited, resulting in insufficient high-temperature performance of the battery. In view of this, the inventors found through a lot of research that, when the percentage mass content (m) of the compound represented by structural formula 1 in the non-aqueous electrolyte, the mass of the single-sided negative electrode material layer (n) on the negative electrode per unit area and the specific surface area (a) of the negative electrode active material satisfy the relational expression 1.5≤m/(n*a)≤600, and 0.05≤m≤5, 0.006≤n≤0.02, 0.6≤a≤2, lithium-ion batteries can achieve good performances at both high and low temperatures.

### DETAILED DESCRIPTION OF PREFERRED EMBODIMENTS

In order to make the technical problems, technical solutions and beneficial effects of the present application more clear, the application will be further explained in detail below with reference to the drawings and embodiments. It should be understood that the specific embodiments described here are only used to illustrate the application, rather than to limit the application.

The embodiment of the application provides a lithium-ion battery, including a positive electrode, a negative electrode and a non-aqueous electrolyte, and the positive electrode includes a positive electrode material layer, the positive electrode material layer includes a positive electrode active material containing a lithium cobalt oxide, the negative electrode includes a negative electrode current collector and a negative electrode material layer formed on the negative electrode current collector, the negative electrode material layer includes a negative electrode active material, the non-aqueous electrolyte includes a non-aqueous organic solvent, a lithium salt and an additive, and the non-aqueous organic solvent includes a carboxylic ester, and the additive includes a compound represented by structural formula 1:

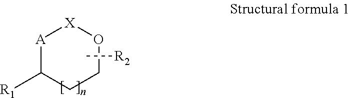

n is 0 or 1, A is selected from C or O, X is selected from

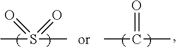

R₁ and R₂ are independently selected from H,

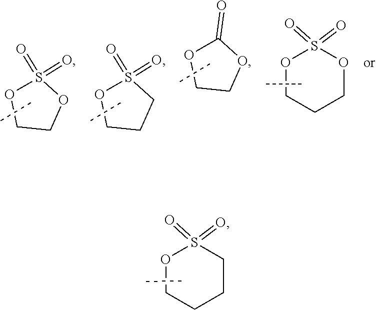

R₁ and R₂ are not selected from H at the same time, and X, R₁ and R₂ contain at least one sulfur atom;
the lithium-ion battery meets the following requirements:
1.5≤m/(n*a)≤600, and 0.05≤m≤5, 0.006≤n≤0.02, 0.6≤a≤2;
m is a percentage mass content of the compound represented by structural formula 1 in the non-aqueous electrolyte, in %;
n is a mass of the single-sided negative electrode material layer on the negative electrode per unit area, in g/cm²; and
a is a specific surface area of the negative electrode active material, in m²/g.

Lithium cobalt oxide is adopted as the positive electrode active material for lithium-ion battery, allowing the lithium-ion battery to have higher energy density and higher working voltage. Through a lot of innovative research, the inventor found that by adding the compound represented by structural formula 1 as an additive in the non-aqueous electrolyte containing carboxylic ester solvent, and managing the relationship of the percentage mass content (m) of the compound represented by structural formula 1 in the non-aqueous electrolyte, the mass of the single-sided negative electrode material layer (n) on the negative electrode per unit area and the specific surface area (a) of the negative electrode active material, the low and high temperature performances can be balanced for lithium ion batteries with high voltage and high compaction density. The reason is that the compound represented by structural formula 1 participates in the film formation on the surface of the negative electrode, and the surface of the negative electrode is the main place where the compound represented by structural formula 1 plays its role, so the reaction area of the negative electrode has a great influence on the action effect of the additive, and the negative electrode reaction area is directly related to the mass of the single-sided negative electrode material layer (n) on the negative electrode per unit area and the specific surface area (a) of the negative electrode active material. If the reaction area of the negative electrode is small, the additive film is too thick in the negative electrode region, which can improve the reduction of carboxylate oxidation products at the negative electrode, but it causes high basic impedance, which is not conducive to the low temperature performance of the battery. If the reaction area of the negative electrode is too large, the additive film can not completely cover the negative electrode, and the reduction of carboxylate oxidation products at the negative electrode can not be effectively inhibited, resulting in insufficient high-temperature performance of the battery. In view of this, the inventors found through a lot of research that, when the percentage mass content (m) of the compound represented by structural formula 1 in the non-aqueous electrolyte, the mass of the single-sided negative electrode material layer (n) on the negative electrode per unit area and the specific surface area (a) of the negative electrode active material satisfy the relational expression 1.5≤m/(n*a)≤600, and 0.05≤m≤5, 0.006≤n≤0.02, 0.6≤a<2, lithium-ion batteries can achieve good performances at both high and low temperatures.

In some embodiments, when n is 0, the compound represented by structural formula 1 is:

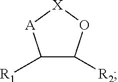

A is selected from C or O, X is selected from

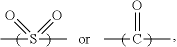

R₁ and R₂ are independently selected from H,

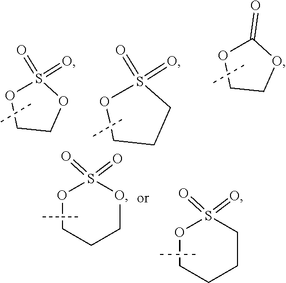

R₁ and R₂ are not selected from H at the same time, and X, R₁ and R₂ contain at least one sulfur atom.

In some embodiments, when n is 1, the compound represented by structural formula 1 is:

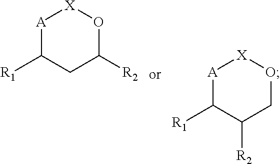

A is selected from C or O, X is selected from

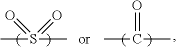

R₁ and R₂ are independently selected from H,

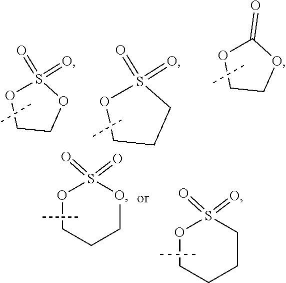

R₁ and R₂ are not selected from H at the same time, and X, R₁ and R₂ contain at least one sulfur atom.

In some embodiments, the percentage mass content of the carboxylic ester is 10%-55% based on the total mass of the non-aqueous electrolyte being 100%.

Specifically, the percentage mass content of the carboxylic acid ester may be 10%, 11%, 13%, 15%, 18%, 20%, 23%, 27%, 30%, 33%, 37%, 40%, 43%, 47%, 50% or 55%, based on the total mass of the non-aqueous electrolyte being 100%.

In a preferred embodiment, the percentage mass content of the carboxylic ester is 15%-50% based on the total mass of the non-aqueous electrolyte being 100%.

Carboxylic acid ester has the characteristics of high dielectric constant and low viscosity. Adding carboxylic acid ester into non-aqueous electrolyte is beneficial to improve the low-temperature and fast-charging performance of the battery. However, carboxylic acid ester is unstable at high voltage, and it is likely to produce decomposition products on the positive electrode, especially the decomposition products will be reduced when they migrate to the negative electrode, resulting in the loss of active Li and the increase of battery impedance, thus deteriorating the capacity after storage. When the content of carboxylic ester is in the above range, the low-temperature performance of the battery can be better improved. Meanwhile, by managing the percentage mass content (m) of the compound represented by structural formula 1 in the non-aqueous electrolyte, the mass of the single-sided negative electrode material layer (n) on the negative electrode per unit area and the specific surface area (a) of the negative electrode active material, a stable interface film can be formed on the negative electrode surface, so that the non-aqueous electrolyte with carboxylic ester can maintain good cycle performance under the conditions of high temperature and high voltage.

In a preferred embodiment, the lithium-ion battery meets the following requirements:
5≤m/(n*a)≤300.

With the definition of the above relationship, the influences of the percentage mass content (m) of the compound represented by structural formula 1 in the non-aqueous electrolyte, the mass of the single-sided negative electrode material layer (n) on the negative electrode per unit area and the specific surface area (a) of the negative electrode active material on the battery performance can be further managed integratively, and the low-temperature performance and high-temperature performance of the lithium-ion battery can be improved.

In a specific embodiment, the percentage mass content (m) of the compound represented by structural formula 1 in the non-aqueous electrolyte may be 0.05%, 0.08%, 0.1%, 0.2%, 0.4%, 0.5%, 0.7%, 0.9%, 1.0%, 1.1%, 1.3%, 1.5%, 1.8%, 2.0%, 2.3%, 2.7%, 3.0%, 3.3%, 3.7%, 4.0%, 4.3%, 4.7% or 5.0%.

In a preferred embodiment, the percentage mass content (m) of the compound represented by structural formula 1 in the non-aqueous electrolyte is 0.1%-3%.

The content of the compound represented by structural formula 1 is related to the thickness of the interface film formed on the surface of the negative electrode material layer. When the content of the compound represented by structural formula 1 in the non-aqueous electrolyte is within the above range, it is beneficial to form an interface film with an appropriate and stable thickness on the surface of the negative electrode material layer, effectively inhibiting the decomposition of carboxylic acid esters in the non-aqueous electrolyte, and avoiding the influence of the excessive thickness of the interface film on the low-temperature impedance of the battery.

In a specific embodiment, the mass of the single-sided negative electrode material layer (n) on the negative electrode per unit area may be 0.006 g/cm², 0.007 g/cm², 0.008 g/cm², 0.009 g/cm², 0.01 g/cm², 0.011 g/cm², 0.012 g/cm², 0.013 g/cm², 0.014 g/cm², 0.015 g/cm², 0.017 g/cm², 0.018 g/cm² or 0.02 g/cm².

In a preferred embodiment, the mass of the single-sided negative electrode material layer (n) on the negative electrode per unit area is 0.008-0.015 g/cm².

With the decrease of the mass of the single-sided negative electrode material layer (n) on the negative electrode per unit area, it is beneficial to improve the diffusion efficiency of non-aqueous electrolyte in the pores of the negative electrode material layer. This improves the ion conductivity and reduce the impedance of lithium-ion battery at low temperature. Meanwhile, the decrease of the mass of the single-sided negative electrode material layer (n) on the negative electrode per unit area will also lead to the decrease of the energy density of the battery, which will affect the stability of the negative electrode material and easily lead to the problem of negative electrode pulverization. However, the greater the mass of the single-sided negative electrode material layer (n) on the negative electrode per unit area, the more beneficial it is to improve the energy density of the battery, but it is not conducive to the the non-aqueous electrolyte infiltration, and the dynamics of lithium ion batteries becomes worse, which affects the high-temperature performance of the lithium ion batteries. Therefore, when the mass of the single-sided negative electrode material layer (n) on the negative electrode per unit area falls within the above-mentioned preferred range, the dynamic performance of the battery can be better improved, so that the lithium-ion battery has higher energy density and ion conductivity.

In specific embodiments, the specific surface area (a) of the negative electrode active material may be 6 m²/g, 0.7 m²/g, 0.8 m²/g, 0.9 m²/g, 1.0 m²/g, 1.1 m²/g, 1.2 m²/g, 1.3 m²/g, 1.4 m²/g, 1.5 m²/g, 1.6 m²/g, 1.7 m²/g, 1.8 m²/g, 1.9 m²/g or 2 m²/g.

In a preferred embodiment, the specific surface area (a) of the negative electrode active material is 0.7-1.6 m²/g.

The deintercalation reaction of lithium-ions mainly happens on the interface between negative electrode active material and non-aqueous electrolyte. Under the premise of the same apparent volume and full immersion of organic non-aqueous electrolyte, the larger the specific surface area of negative electrode active material, the larger the interface between the electrode and non-aqueous electrolyte, the faster the deintercalation speed of lithium ion and the higher the ionic conductivity of negative electrode. However, the increase of specific surface area is likely to lead to insufficient structural strength of the negative electrode material layer, which will lead to the problem of material shedding and aggravate the decomposition of non-aqueous electrolyte. Meanwhile, the specific surface area (a) of the negative electrode active material directly affects the film-forming thickness of the compound represented by structural formula 1 per unit mass on the surface of the negative electrode material layer, which is correlated with the content of the compound represented by structural formula 1 in the non-aqueous electrolyte.

In some embodiments, the compound represented by structural formula 1 is selected from one or more of the following compounds:

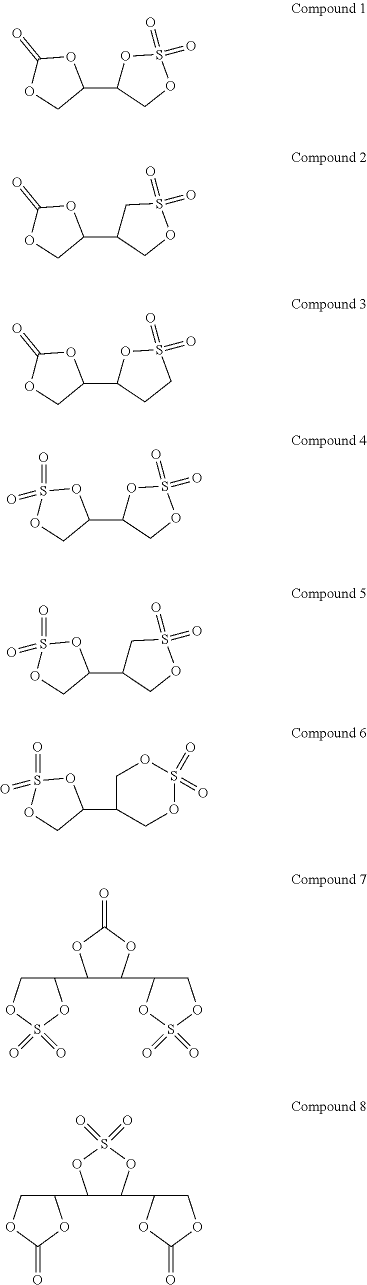

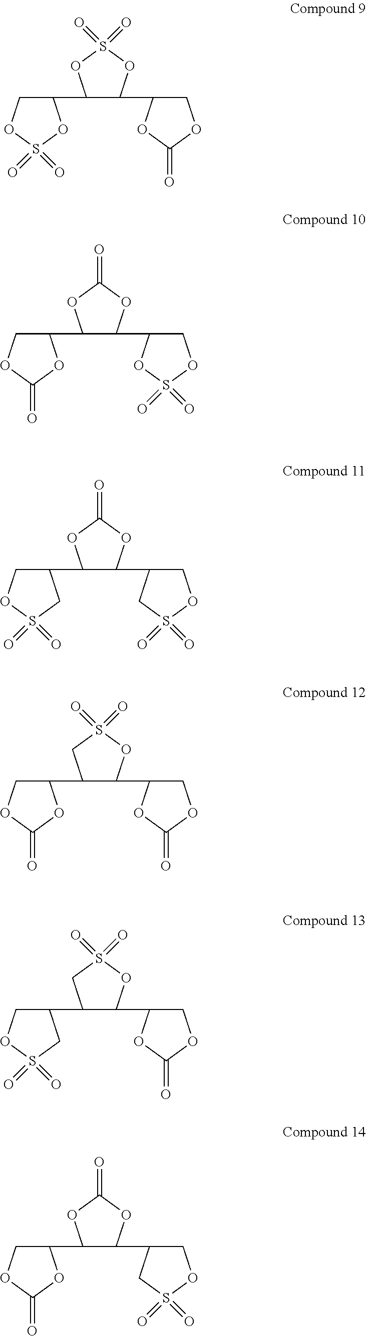 [SMILES: O=C1OCC(C2OS(=O)(=O)OC2C2COS(=O)(=O)O2)O1 ; O=C1OCC(C2OC(=O)OC2C2COS(=O)(=O)O2)O1 ; O=C1OC(C2COS(=O)(=O)C2)C(C2COS(=O)(=O)C2)O1 ; O=C1OCC(C2CS(=O)(=O)OC2C2COC(=O)O2)O1 ; O=C1OCC(C2OS(=O)(=O)CC2C2COS(=O)(=O)C2)O1 ; O=C1OCC(C2OC(=O)OC2C2COS(=O)(=O)C2)O1]

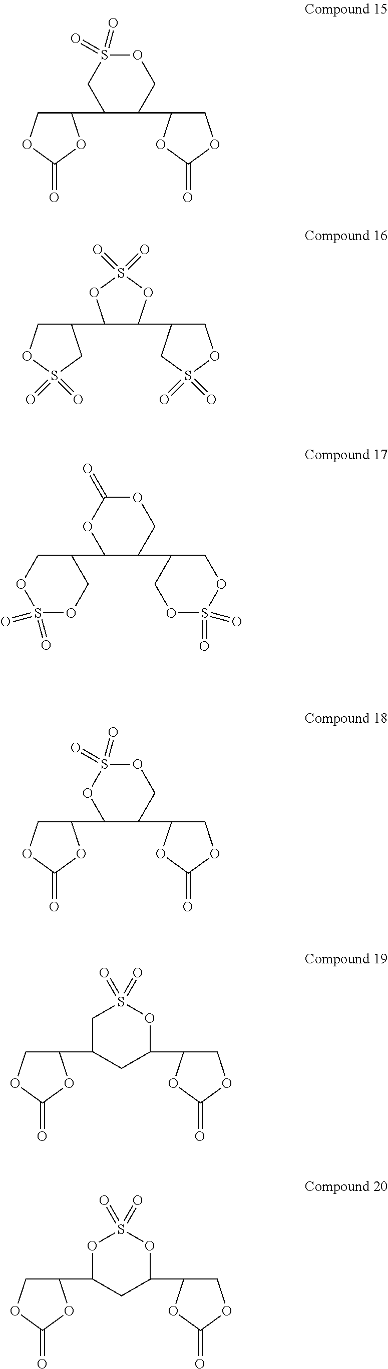 [SMILES: O=C1OCC(C2COS(=O)(=O)CC2C2COC(=O)O2)O1 ; O=S1(=O)CC(C2OS(=O)(=O)OC2C2COS(=O)(=O)C2)CO1 ; O=C1OCC(C2COS(=O)(=O)OC2)C(C2COS(=O)(=O)OC2)O1 ; O=C1OCC(C2COS(=O)(=O)OC2C2COC(=O)O2)O1 ; O=C1OCC(C2CC(C3COC(=O)O3)OS(=O)(=O)C2)O1 ; O=C1OCC(C2CC(C3COC(=O)O3)OS(=O)(=O)O2)O1]

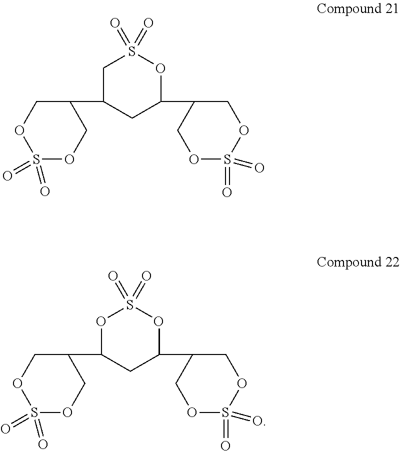 [SMILES: O=S1(=O)CC(C2COS(=O)(=O)OC2)CC(C2COS(=O)(=O)OC2)O1 ; O=S1(=O)OCC(C2CC(C3COS(=O)(=O)OC3)OS(=O)(=O)O2)CO1]

It should be noted that the above are merely the preferred compounds of the present application, not the limitation of the present application.

With the structural formula of the compound represented by structural formula 1, a person skilled in the art may obtain the preparation methods of the above compounds according to the common knowledge in the chemical synthesis field. For example, compound 7 may be prepared by the following method.

Put organic solvents such as sorbitol, dimethyl carbonate, methanol alkaline catalyst potassium hydroxide and DMF into a reaction container, allow them to react for several hours under heating conditions, add a certain amount of oxalic acid to adjust the pH value to be neutral, then filter and recrystallize to obtain an intermediate product 1, and then perform esterification reaction on the intermediate product 1, carbonate, thionyl chloride and the like under high temperature conditions to obtain an intermediate product 2, and oxidize the intermediate product 2 by using an oxidant such as sodium periodate and the like to obtain a compound 7.

In some embodiments, the lithium-ion battery is a pouch battery or an ebonite battery.

In some embodiments, the positive electrode further includes an positive electrode current collector, and the positive electrode material layer is formed on the surface of the positive electrode current collector.

The positive electrode current collector is selected from metal materials that can conduct electrons. Preferably, the positive electrode current collector includes at least one of Al, Ni, tin, copper and stainless steel. In a more preferred embodiment, the positive electrode current collector is selected from aluminum foil.

In some embodiments, the positive electrode material layer further includes a positive electrode binder and a positive electrode conductive agent.

The positive electrode binder includes one or more of polyvinylidene fluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer; thermoplastic resins such as vinylidene fluoride-tetrafluoroethylene copolymer, vinylidene fluoride-trifluoroethylene copolymer, vinylidene fluoride-trichloroethylene copolymer, vinylidene fluoride-fluoroethylene copolymer, vinylidene fluoride-hexafluoropropylene-tetrafluoroethylene copolymer, thermoplastic polyimide, polyethylene and polypropylene; acrylic resin; sodium hydroxymethylcellulose; and styrene butadiene rubber.

The positive electrode conductive agent includes at least one of a conductive carbon black, conductive carbon sphere, conductive graphite, conductive carbon fibers, carbon nanotube, graphene or reduced graphene oxide.

In a preferred embodiment, the negative electrode active material includes at least one of a carbon-based negative electrode, a silicon-based negative electrode, a tin-based negative electrode and a lithium negative electrode. The carbon-based negative electrode may include graphite, hard carbon, soft carbon, graphene, mesophase carbon microspheres, etc. The silicon-based negative electrode may include silicon material, silicon oxide, silicon-carbon composite material, silicon alloy material, etc. The tin-based negative electrode may include tin, tin carbon, tin oxide and tin metal compounds. The lithium negative electrode may include metallic lithium or lithium alloy. The lithium alloy may be at least one of lithium silicon alloy, lithium sodium alloy, lithium potassium alloy, lithium aluminum alloy, lithium tin alloy and lithium indium alloy.

In some embodiments, the negative electrode material layer further includes a negative electrode binder and a negative electrode conductive agent. The negative electrode active material, the negative electrode binder and the negative electrode conductive agent are blended to obtain the negative electrode material layer.

The possible ranges of the negative electrode binder and the negative electrode conductive agent are the same as those of the positive electrode binder and the positive electrode conductive agent respectively, and the details are not repeated here.

In some embodiments, the negative electrode plate further includes a negative electrode current collector, and the negative electrode material layer is formed on the surface of the negative electrode current collector.

The negative current collector is selected from metal materials that can conduct electrons. Preferably, the negative current collector includes one or more of Al, Ni, tin, copper and stainless steel. In a more preferred embodiment, the negative current collector is selected from copper foil.

In some embodiments, the arboxylic acid solvent includes cyclic carboxylic ester and/or chain carbonic ester.

Examples of cyclic carboxylic ester include one or more of γ-butyrolactone, γ-valerolactone and δ-valerolactone. Examples of chain carbonic ester include one or more of methyl acetate (MA), ethyl acetate (EA), n-propyl acetate (EP), butyl acetate, propyl propionate (PP) and butyl propionate.

In some embodiments, the non-aqueous organic solvent further includes at least one of ether solvent, nitrile solvent, carbonate solvent and sulfone solvent.

In some embodiments, the ether solvent includes cyclic ether or chain ether, preferably chain ether with 3-10 carbon atoms and cyclic ether with 3-6 carbon atoms, and the specific cyclic ether may be but are not limited to 1,3-dioxolane (DOL), 1,4-dioxooxane (DX), crown ether, tetrahydrofuran (THF), 2-methyltetrahydrofuran (2-CH3-THF) and 2-trifluoromethyltetrahydrofuran (2-CF₃-THF). Specifically, the chain ether may be but not limited to dimethoxymethane, diethoxymethane, ethoxymethoxymethane, ethylene glycol di-n-propyl ether, ethylene glycol di-n-butyl ether and diethylene glycol dimethyl ether. Dimethoxymethane, diethoxymethane and ethoxymethoxymethane with low viscosity and high ionic conductivity arc particularly preferred because the solvability of chain ether and lithium-ions is high and the ion dissociation can be improved. Ether compounds may be used alone or in any combinations and ratios of two or more kinds. The addition amount of ether compound is not particularly limited, which is within the range of not significantly damaging the effect of the high-voltage lithium-ion battery of the present application. In the non-aqueous solvent volume ratio of 100%, the volume ratio is usually 1% or more, preferably 2% or more, more preferably 3% or more. Moreover, the volume ratio is usually 30% or less, preferably 25% or less, and more preferably 20% or less. When two or more ether compounds are used in combination, the total amount of ether compounds only needs to be in the above range. When the addition amount of ether compounds is within the above preferred range, it is easy to ensure the improvement effects of ionic conductivity brought by the increase of lithium-ion dissociation degree and the decrease of viscosity of chain ether. In addition, when the negative electrode active material is a carbon material, the co-intercalation reaction of the chain ether and lithium-ions can be suppressed, so that the input-output characteristics and the charge-discharge rate characteristics can be within an appropriate range.

In some embodiments, the nitrile solvent can be at least one of acetonitrile, glutaronitrile and malononitrile.

In some embodiments, the carbonate solvent includes a cyclic carbonate or a chain carbonate. The cyclic carbonate may be but not limited to one or more of ethylene carbonate (EC), propene carbonate (PC), y-butyrolactone (GBL) and butylene carbonate (BC). The chain carbonate may be but not limited to one or more of dimethyl carbonate (DMC), ethyl methyl carbonate (EMC), diethyl carbonate (DEC) and dipropyl carbonate (DPC). The content of cyclic carbonate is not particularly limited, which is within the range of not significantly damaging the effect of the high-voltage lithium-ion battery of the present application. However, in the case where one is used alone, the minimal content is usually 3% by volume or more, preferably 5% by volume or more, relative to the total amount of the solvent in the non-aqueous electrolyte. With this range, the decrease of conductivity caused by the decrease of the dielectric constant of the non-aqueous electrolyte can be avoided, so the high-current discharge characteristics, the stability with respect to the negative electrode and the cycle characteristics of the non-aqueous electrolyte battery can easily reach a good range. In addition, the maximum content is usually 90% or less by volume, preferably 85% or less by volume, and more preferably 80% or less by volume. With this range, the oxidation/reduction resistance of the non-aqueous electrolyte can be improved, thus contributing to the improvement of the stability during high-temperature storage. The content of the chain carbonate is not particularly limited, but it is usually 15% or more by volume, preferably 20% or more by volume, and more preferably 25% or more by volume, relative to the total amount of the solvent in the non-aqueous electrolyte. In addition, the volume ratio is usually 90% or less, preferably 85% or less, and more preferably 80% or less. By setting the content of the chain carbonate in the above range, the viscosity of the non-aqueous electrolyte can be easily kept with an appropriate range, and the decrease of ionic conductivity can be suppressed, thus contributing to a good range of the output characteristics of the non-aqueous electrolyte battery. When two or more kinds of chain carbonates are used in combination, the total amount of the chain carbonate only needs to be in the above range.

In some embodiments, it is also preferable to use chain carbonates with fluorine atoms (hereinafter referred to as “fluorinated chain carbonates”). The number of fluorine atoms in the fluorinated chain carbonate is not particularly limited as long as it is 1 or more, but it is usually 6 or less, preferably 4 or less. When the fluorinated chain carbonate has multiple fluorine atoms, these fluorine atoms can be bonded to the same carbon or to different carbons. Examples of the fluorinated chain carbonates include fluorinated dimethyl carbonate derivatives, fluorinated ethyl methyl carbonate derivatives and fluorinated diethyl carbonate derivatives.

In some embodiments, sulfone solvent includes cyclic sulfones and chain sulfones, but preferably, in the case of cyclic sulfones, it is usually a compound with 3-6 carbon atoms, preferably 3-5 carbon atoms; and in the case of chain sulfones, it is usually a compound with 2-6 carbon atoms, preferably 2-5 carbon atoms. The addition amount of the sulfone solvent is not particularly limited, which is within the range of not significantly damaging the effect of the lithium-ion battery of the present application. Compared with the total amount of solvent in non-aqueous electrolyte, the volume ratio is usually 0.3% or more, preferably 0.5% or more, more preferably 1% or more. Moreover, the volume ratio is usually 40% or less, preferably 35% or less, and more preferably 30% or less. When two or more kinds of sulfone solvent are used in combination, the total amount of the sulfone solvents only needs to meet the above range. When the addition amount of sulfone solvent is within the above range, the non-aqueou electrolyte with excellent high-temperature storage stability is easily to be obtained.

In some embodiments, the lithium salt includes at least one of LiPF₆, LiBOB, LiDFOB, LiPO₂F₂, LiBF₄, LiSbF₆, LiAsF₆, LIN (SO₂CF₃)₂, LIN (SO₂C₂F₅)₂, LiC(SO₂CF₃)₃, LIN (SO₂F)₂, LiCIO₄, LiAICI₄, LiCF₃SO₃, Li₂B₁₀Cl₁₀, LiSO₂F, LiTOP (lithium oxalate phosphate), LiDODFP (lithium difluoro oxalate phosphate), LiOTFP (lithium tetrafluorooxalate phosphate) and lithium salts of lower aliphatic carboxylic acids.

In some embodiments, the concentration of the lithium salt in the non-aqueous electrolyte is 0.1 mol/L-8 mol/L. In a preferred embodiment, the concentration of the lithium salt in the non-aqueous electrolyte is 0.5 mol/L-2.5 mol/L. Specifically, the concentration of the lithium salt in the non-aqueous electrolyte may be 0.5 mol/L, 1 mol/L, 1.5 mol/L, 2 mol/L and 2.5 mol/L.

In some embodiments, the additive further includes at least one of cyclic sulfate compounds, sultone compounds, cyclic carbonate compounds, phosphate compounds, borate compounds and nitrile compounds.

Preferably, the content of the additive is 0.01%-30% based on the total mass of the non-aqueous electrolyte being 100% being 100%.

In some embodiments, the cyclic sulfate compound is selected from at least one of ethylene sulfate, propylene sulfate, methyl ethylene sulfate,

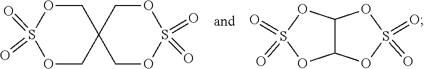 [SMILES: O=S1(=O)OCC2(CO1)COS(=O)(=O)OC2 ; O=S1(=O)OC2OS(=O)(=O)OC2O1]

the sultone compound is at least one selected from the group consisting of 1,3-propane sultone, 1,4-butane sultone and 1,3-propylene sultone;
the cyclic carbonate compound is selected from at least one of vinylene carbonate, vinylethylene carbonate, methylene ethylene carbonate, fluoroethylene carbonate, trifluoromethyl ethylene carbonate, bis-fluoroethylene carbonate or a compound represented by structural formula 2;

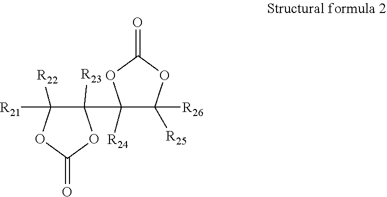

in structural formula 2, R21, R22, R23, R24, R25 and R26 are independently selected from one of hydrogen atom, halogen atom and C1-C5 group;
the phosphate compound is selected from at least one of tri (trimethylsilane) phosphate, tri (trimethylsilane) phosphite or a compound represented by structural formula 3:

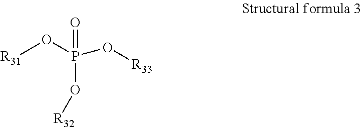

in structural formula 3, R₃₁, R₃₂ and R₃₃ are independently selected from a C1-C5 saturated hydrocarbon group, an unsaturated hydrocarbon group, a halogenated hydrocarbon group and—Si(CₘH₂ₘ₊₁)₃, m is a natural number of 1-3, and at least one of R₃₁, R₃₂ and R₃₃ is unsaturated hydrocarbon group.

In a preferred embodiment, the phosphate compound represented by structural formula 3 may be at least one selected from the group consisting of phosphoric acid tripropargyl ester, dipropargyl methyl phosphonate, dipropargyl ethyl phosphate, dipropargyl propyl phosphate, dipropargyl trifluoromethyl phosphate, dipropargyl-2, 2, 2-trifluoroethyl phosphate, dipropargyl-3, 3, 3-trifluoropropyl phosphate, dipropargyl hexafluoroisopropyl phosphate, phosphoric acid triallyl ester, diallyl methyl phosphate, diallyl ethyl phosphate, diallyl propyl phosphate, diallyl trifluoromethyl phosphate, diallyl-2, 2, 2-trifluoroethyl phosphate, diallyl-3, 3, 3-trifluoropropyl phosphate or diallyl hexafluoroisopropyl phosphate;
the borate compound is selected from at least one of tris (trimethylsilane) borate and tris (triethyl silicane) borate; and
the nitrile compound is selected from one or more of butanedinitrile, glutaronitrile, ethylene glycol bis (propionitrile) ether, hexanetricarbonitrile, adiponitrile, pimelic dinitrile, hexamethylene dicyanide, azelaic dinitrile and sebaconitrile.

In other embodiments, the additive may also include other additives that can improve the performance of the battery. For example, additives that can improve the safety performance of the battery, flame retardant additives such as fluorophosphate and cyclophosphazene, or overcharge prevention additives such as tert.-amylbenzene and tert-butyl benzene.

It should be noted that, unless otherwise specified, in general, the content of any optional substance for the additive in the non-aqueous electrolyte is less than 10%, preferably 0.1-5%, and more preferably 0.1%-2%. Specifically, the content of any optional substance fro the additive may be 0.05%, 0.08%, 0.1%, 0.5%, 0.8%, 1%, 1.2%, 1.5%, 1.8%, 2%, 2.2%, 2.5%, 2.8%, 3%, 3.2%, 3.5%, 3.8%, 4%, 4.5%, 5%, 5.5%, 6%, 6.5%, 7%, 7.5%, 7.8%, 8%, 8.5%, 9%, 9.5% and 10%.

In some embodiments, when the additive is selected from fluoroethylene carbonate, the content of the fluoroethylene carbonate is 0.05%-30% based on the total mass of the non-aqueous electrolyte being 100%.

In some embodiments, the lithium-ion battery further includes a separator, and the separator is positioned between the positive electrode and the negative electrode.

The separator is an existing conventional diaphragm, which may be a ceramic diaphragm, a polymer diaphragm, a nonwoven fabric, an inorganic-organic composite diaphragm, etc. The polymer diaphragm is selected from one or more of polyolefins, polyamides, polysulfones, polyphosphazenes, polyethersulfones, polyetheretherketones, polyetheramides and polyacrylonitrile, including but not limited to single-layer PP (polypropylene), single-layer PE (polyethylene), double-layer PP/PE, double-layer PP/PP, triple-layer PP/PE/PP and other diaphragm.

In a preferred embodiment, the separator includes a substrate diaphragm and a surface coating, and the surface coating is inorganic particles or organic gel or a mixture of the two and is coated on at least one side surface of the substrate diaphragm.

The present application will be further illustrated with embodiments and examples.

The compounds mentioned in the following embodiments and comparative examples are shown in the following table:

TABLE 1

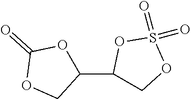 [SMILES: O=C1OCC(C2COS(=O)(=O)O2)O1]

Compound 1

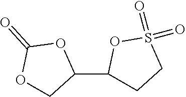 [SMILES: O=C1OCC(C2CCS(=O)(=O)O2)O1]

Compound 3

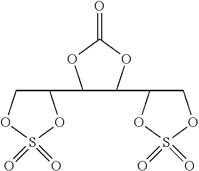 [SMILES: O=C1OC(C2COS(=O)(=O)O2)C(C2COS(=O)(=O)O2)O1]

Compound 7

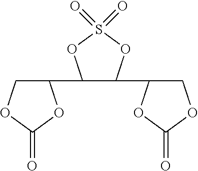 [SMILES: O=C1OCC(C2OS(=O)(=O)OC2C2COC(=O)O2)O1]

Compound 8

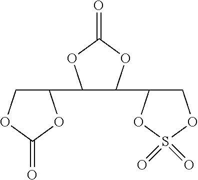 [SMILES: O=C1OCC(C2OC(=O)OC2C2COS(=O)(=O)O2)O1]

Compound 10

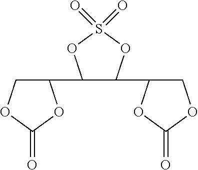 [SMILES: O=C1OCC(C2OS(=O)(=O)OC2C2COC(=O)O2)O1]

Compound 12

TABLE 2
Parameter Design of Embodiments and Comparative examples

| | | | | | | Mass of the | | |
|---|---|---|---|---|---|---|---|---|
| | | | | | | single- | | |
| | | Percentage | | | | sided | | |
| | | mass content | | Carboxylic | | negative | Specific | |
| | | (m) of the | | acid ester | | electrode | surface | |
| | | compound | | in non- | | material | area (a) | |
| | | represented by | | aqueous | Other | layer (n) on | of the | |
| | | structural | | electrolyte | additives | the | negative | |
| | Compounds | formula 1 in | | and its | and their | negative | electrode | |
| | represented | the non- | | percentage | percentage | electrode | active | |
| | by structural | aqueous | | mass | mass | per unit | material | |
| Group | formula 1 | electrolyte/% | Carboxylic ester | content/% | contents/% | area g/cm² | m²/g | m/(n*a) |
| Embodiment 1 | Compound 7 | 0.05 | Propyl propionate | 30 | — | 0.018 | 1.85 | 1.5 |
| Embodiment 2 | Compound 7 | 0.05 | Propyl propionate | 10 | — | 0.006 | 1.8 | 4.6 |
| Embodiment 3 | Compound 7 | 0.1 | Propyl propionate | 30 | — | 0.010 | 2.0 | 5.0 |
| Embodiment 4 | Compound 7 | 0.2 | Propyl propionate | 40 | — | 0.010 | 1.8 | 11.1 |
| Embodiment 5 | Compound 7 | 0.5 | Propyl propionate | 40 | — | 0.012 | 1.7 | 24.5 |
| Embodiment 6 | Compound 7 | 1.0 | Propyl propionate | 30 | — | 0.014 | 1.6 | 44.6 |
| Embodiment 7 | Compound 7 | 1.0 | Propyl propionate | 20 | — | 0.014 | 1.4 | 51.0 |
| Embodiment 8 | Compound 7 | 1.0 | Propyl propionate | 40 | — | 0.014 | 1.3 | 54.9 |
| Embodiment 9 | Compound 7 | 1.2 | Propyl propionate | 40 | — | 0.010 | 1.3 | 92.3 |
| Embodiment 10 | Compound 7 | 1.2 | Propyl propionate | 50 | — | 0.013 | 1.25 | 73.8 |
| Embodiment 11 | Compound 7 | 1.5 | Propyl propionate | 40 | — | 0.012 | 1.2 | 104.2 |
| Embodiment 12 | Compound 7 | 1.5 | Propyl propionate | 30 | — | 0.008 | 1.0 | 187.5 |
| Embodiment 13 | Compound 7 | 2.0 | Propyl propionate | 50 | — | 0.015 | 0.9 | 148.1 |
| Embodiment 14 | Compound 7 | 2.5 | Propyl propionate | 50 | — | 0.008 | 1.1 | 300.3 |
| Embodiment 15 | Compound 7 | 3.0 | Propyl propionate | 40 | — | 0.008 | 1.0 | 375.0 |
| Embodiment 16 | Compound 7 | 3.0 | Propyl propionate | 45 | — | 0.009 | 0.8 | 416.7 |
| Embodiment 17 | Compound 7 | 4.0 | Propyl propionate | 55 | — | 0.010 | 0.8 | 481.9 |
| Embodiment 18 | Compound 7 | 4.5 | Propyl propionate | 40 | — | 0.010 | 0.8 | 542.2 |
| Embodiment 19 | Compound 7 | 5.0 | Propyl propionate | 60 | — | 0.010 | 0.8 | 598.8 |
| Embodiment 20 | Compound 7 | 1.0 | Propyl propionate | 40 | — | 0.020 | 1.3 | 38.5 |
| Embodiment 21 | Compound 7 | 2.0 | Propyl propionate | 50 | — | 0.015 | 0.6 | 222.2 |
| Embodiment 22 | Compound 1 | 1.5 | Propyl propionate | 40 | — | 0.012 | 1.2 | 104.2 |
| Embodiment 23 | Compound 3 | 1.5 | Propyl propionate | 40 | — | 0.012 | 1.2 | 104.2 |
| Embodiment 24 | Compound 8 | 1.5 | Propyl propionate | 40 | — | 0.012 | 1.2 | 104.2 |
| Embodiment 25 | Compound 10 | 1.5 | Propyl propionate | 40 | — | 0.012 | 1.2 | 104.2 |
| Embodiment 26 | Compound 12 | 1.5 | Propyl propionate | 40 | — | 0.012 | 1.2 | 104.2 |
| Embodiment 27 | Compound 7 | 1.5 | Ethyl propionate | 40 | — | 0.012 | 1.2 | 104.2 |
| Embodiment 28 | Compound 7 | 1.5 | Ethyl acetate | 40 | — | 0.012 | 1.2 | 104.2 |
| Embodiment 29 | Compound 7 | 1.5 | Ethyl difluoroacetate | 40 | — | 0.012 | 1.2 | 104.2 |
| Embodiment 30 | Compound 7 | 1.5 | Propyl propionate | 40 | FEC:3 | 0.012 | 1.2 | 104.2 |
| Embodiment 31 | Compound 7 | 1.5 | Propyl propionate | 40 | SN:1 | 0.012 | 1.2 | 104.2 |
| Embodiment 32 | Compound 7 | 1.5 | Propyl propionate | 40 | PS:1 | 0.012 | 1.2 | 104.2 |
| Embodiment 33 | Compound 7 | 1.5 | Propyl propionate | 40 | HTCN:1 | 0.012 | 1.2 | 104.2 |
| Comparative example 1 | — | — | Propyl propionate | 40 | — | 0.012 | 1.2 | — |
| Comparative example 2 | Compound 7 | 0.05 | Propyl propionate | 40 | — | 0.018 | 2.0 | 1.39 |
| Comparative example 3 | Compound 7 | 5.0 | Propyl propionate | 50 | — | 0.010 | 0.83 | 602.4 |
| Comparative example 4 | Compound 7 | 0.05 | Propyl propionate | 40 | — | 0.020 | 1.7 | 1.47 |
| Comparative example 5 | Compound 7 | 0.05 | Propyl propionate | 50 | — | 0.019 | 1.8 | 1.46 |
| Comparative example 6 | Compound 7 | 4.5 | Propyl propionate | 40 | — | 0.009 | 0.7 | 714.3 |
| Comparative example 7 | Compound 7 | 3.0 | Propyl propionate | 50 | — | 0.006 | 0.8 | 625.0 |
| Comparative example 8 | Compound 7 | 0.03 | Propyl propionate | 30 | — | 0.010 | 0.7 | 4.3 |
| Comparative example 9 | Compound 7 | 5.50 | Propyl propionate | 40 | — | 0.014 | 1.3 | 302.2 |
| Comparative example 10 | Compound 7 | 1.0 | Propyl propionate | 30 | — | 0.004 | 1.4 | 178.6 |
| Comparative example 11 | Compound 7 | 1.5 | Propyl propionate | 30 | — | 0.030 | 1.4 | 35.7 |
| Comparative example 12 | Compound 7 | 0.8 | Propyl propionate | 30 | — | 0.008 | 0.5 | 200.0 |
| Comparative example 13 | Compound 7 | 1.2 | Propyl propionate | 30 | — | 0.008 | 2.5 | 60.0 |
| Comparative example 14 | Compound 7 | 1.5 | — | — | — | 0.012 | 1.2 | 104.2 |

### EMBODIMENT 1

This embodiment is used to illustrate the lithium-ion battery and its preparation method, including the following steps:

### 1) Preparation of Electrolyte

Ethylene carbonate, dimethyl carbonate and propyl propionate were mixed as non-aqueous organic solvents, then lithium hexafluorophosphate (LiPF₆) was added until the molar concentration was 1 mol/L, and then Compound 7 was added (note: Compound 7 here is the one shown in Table 1, same as the following embodiments). The percentage mass contents of Compound 7 and propyl propionate in non-aqueous electrolyte are shown in Table 2.

### 2) Preparation of Positive Electrode Plate

The positive electrode active materials: LiCoO₂, conductive carbon black Super-P and binder polyvinylidene fluoride (PVDF) were mixed, then they were dispersed in N-methyl-2-pyrrolidone (NMP) to obtain a positive electrode slurry. The slurry was evenly coated on both sides of aluminum foil, dried, calendered and vacuum-dried. A positive electrode plate was obtained by welding aluminum lead wires with an ultrasonic welder, with a thickness of 120-150 μm.

### 3) Preparation of Negative Electrode Plate

The negative electrode active materials of artificial graphite, conductive carbon black Super-P, styrene-butadiene rubber (SBR) and carboxymethyl cellulose (CMC) were mixed, and then they were dispersed in deionized water to obtain a negative electrode slurry. The slurry was evenly coated on both sides of copper foil, dried, calendered and vacuum-dried. A negative electrode plate was obtained by welding nickel lead wires with an ultrasonic welder, with a thickness of 120-150 μm. The mass of the single-sided negative electrode material layer on the negative electrode per unit area, and the specific surface area of the negative electrode active material are shown in Table 2.

### 4) Preparation of Battery Core

A three-layer separator with a thickness of 20 μm was placed between the positive electrode plate and negative electrode plate, and then the sandwich structure consisting of the positive electrode plate, negative electrode plate and separator was wound, and then the wound body was put into an aluminum foil packaging bag and baked in vacuum at 75° C. for 48 hours to obtain a battery core to be injected with liquid.

### 5) Liquid Injection and Formation of Battery Core

In a glove box with the dew point controlled below −40° C., the prepared non-aqueous electrolyte was injected into the battery core, and then it was packed and sealed in vacuum condition and let stand for 24 hours.

Then, formation of the first charge was performed according to the following steps: charging at 0.05C constant current for 180 min, charging at 0.2C constant current to 3.95V, sealing in vaccum condition for the second time, further charging at 0.2C constant current to 4.48V, and discharging at 0.2C constant current to 3.0V.

### EMBODIMENTS 2-33

Embodiments 2-34 are used to illustrate the lithium-ion battery and preparation method disclosed in the present application, including most of the steps in Embodiment 1, with the following differences:
the additives and their contents, carboxylic acid esters and their contents, the mass of the single-sided negative electrode material layer on the negative electrode per unit area, and the specific surface area of the negative electrode active material corresponding to Embodiments 2-33 were adopted according to Table 2.

### Comparative Examples 1-14

Comparative examples 1-14 are used to comparatively illustrate the lithium-ion battery and preparation method disclosed in the present application, including most of the steps in Embodiment 1, with the following differences:

the additives and their contents, carboxylic acid esters and their contents, the mass of the single-sided negative electrode material layer on the negative electrode per unit area, and the specific surface area of the negative electrode active material corresponding to Comparative examples 1-14 were adopted according to Table 2.

### Performance Test

The following performance tests were conducted on the lithium-ion battery prepared above. Low-temperature performance test

At 25° C., the formed battery was charged to 4.48V at 1 C constant current and constant voltage, and then discharged to 2.5V at 1 C constant current, and the discharge capacity was recorded. Then it was charged to 4.48V at 1 C constant current and constant voltage, and was placed in an environment of −20° C. for 12 h, then discharged to 2.5V at 0.3C constant current, and the discharge capacity was recorded. The calculation formula is as follows:

Discharge capacity retention rate (−20° C.) %=discharge capacity at 0.3C (−20° C.)/discharge capacity at 1 C (25° C.)×100%.

### High Temperature Performance Test

The formed battery was charged to 4.48V at 1 C constant current at room temperature, then charged at constant voltage until the current dropped to 0.01C, then discharged at 1 C constant current to 3.0V, and its initial discharge capacity was measured. Then it was charged at 1 C constant current to 4.48V, then stored at 85° C. for 24 hours, and then discharged at 1 C constant current to 3.0V after the battery cooled to room temperature, and its retention capacity was measured. The calculation formula is as follows:

Battery capacity retention rate (%)=retention capacity/initial discharge capacity ×100%.

(1) Test results obtained from Embodiments 1-20 and Comparative examples 1-13 are shown in Table 3.

TABLE 3

| | Discharge capacity | Capacity retention rate |
|---|---|---|
| | retention rate | after 24 hours storage |
| Group | (−20° C.)/% | at 85° C./% |
| Embodiment 1 | 72.8 | 80.6 |
| Embodiment 2 | 70.1 | 82.1 |
| Embodiment 3 | 76.3 | 83.6 |
| Embodiment 4 | 80.5 | 83.7 |
| Embodiment 5 | 80.9 | 84.1 |
| Embodiment 6 | 83.9 | 88.1 |
| Embodiment 7 | 83.6 | 88.4 |
| Embodiment 8 | 84.0 | 88.6 |
| Embodiment 9 | 84.3 | 89.1 |
| Embodiment 10 | 84.4 | 88.7 |
| Embodiment 11 | 85.2 | 93.1 |
| Embodiment 12 | 84.9 | 92.5 |
| Embodiment 13 | 84.7 | 92.6 |
| Embodiment 14 | 81.6 | 90.8 |
| Embodiment 15 | 81.1 | 90.9 |
| Embodiment 16 | 81.0 | 90.6 |
| Embodiment 17 | 83.3 | 88.2 |
| Embodiment 18 | 79.8 | 91.6 |
| Embodiment 19 | 84.2 | 85.9 |
| Embodiment 20 | 81.7 | 87.8 |
| Embodiment 21 | 81.5 | 90.1 |
| Comparative example 1 | 68.1 | 57.6 |
| Comparative example 2 | 70.4 | 66.2 |
| Comparative example 3 | 76.9 | 75.2 |
| Comparative example 4 | 67.7 | 67.1 |
| Comparative example 5 | 67.8 | 67.3 |
| Comparative example 6 | 70.5 | 74.3 |
| Comparative example 7 | 72.6 | 70.1 |
| Comparative example 8 | 69.2 | 68.8 |
| Comparative example 9 | 73.7 | 78.0 |
| Comparative example 10 | 68.3 | 73.8 |
| Comparative example 11 | 71.4 | 76.2 |
| Comparative example 12 | 72.3 | 78.4 |
| Comparative example 13 | 71.7 | 67.6 |

According to the test results of Embodiment 1˜21 and Comparative example 1˜13, for the lithium-ion batteries using lithium cobalt oxide as a positive electrode active material, its electrolyte contains carboxylic ester solvent, and it is added a compound represented by structural formula 1 as an additive. By managing the percentage mass content (m) of the compound represented by structural formula 1 in the non-aqueous electrolyte, the mass of the single-sided negative electrode material layer (n) on the negative electrode per unit area and the specific surface area (a) of the negative electrode active material to meet the conditions: 1.5≤m/(n*a)≤600, and 0.05≤m≤5, 0.006≤n≤0.02, 0.6≤a<2, the obtained lithium ion battery has high capacity retention rate at low temperature, and also has high capacity retention rate after high temperature storage. This indicates that the reaction area of the negative electrode material layer can be changed by adjusting the mass of the single-sided negative electrode material layer (n) on the negative electrode per unit area and the specific surface area (a) of the negative electrode active material, thus affecting the film-forming effect of the compound represented by structural formula 1 on the surface of the negative electrode material layer, allowing the negative electrode reaction area to match with the content of the compound represented by structural formula 1 in non-aqueous electrolyte, so as to obtain an interface film with moderate thickness and stability. Furthermore, the decomposition of carboxylic acid ester is effectively inhibited, the impedance increase of lithium-ion battery at low temperature is reduced, the stability of non-aqueous electrolyte at high temperature is improved, and the decomposition of non-aqueous electrolyte is prevented, so that the lithium-ion battery has better performance at high temperature and low temperature.

It can be seen from the test results of Embodiment 1˜21, when the percentage mass content (m) of the compound represented by structural formula 1 in the non-aqueous electrolyte, the mass of the single-sided negative electrode material layer (n) on the negative electrode per unit area and the specific surface area (a) of the negative electrode active material further satisfy the condition: 5≤m/(n*a)≤300, it is beneficial to further improve the capacity retention rate of the lithium-ion battery at low temperature. It is anticipated that with this range, the cooperation of the mass of the single-sided negative electrode material layer (n) on the negative electrode per unit area and the specific surface area (a) of the negative electrode active material ensures sufficient pore channels in the negative electrode material layer, improves the infiltration effect of the non-aqueous electrolyte on the negative electrode material layer, further reduces the impedance, improves the ion conduction efficiency at low temperature, and further improves the low-temperature capacity retention rate.

It can be seen from the test results of Comparative examples 1-13, if the percentage mass content (m) of the compound represented by structural formula 1 in the non-aqueous electrolyte, the mass of the single-sided negative electrode material layer (n) on the negative electrode per unit area and the specific surface area (a) of the negative electrode active material meet the range limit of 1.5≤m/(n*a)<600, while the value of m, n or a does not fall within the range, the lithium ion battery still does not have a high capacity retention rate at high and low temperatures. For example, it can be seen from Comparative examples 8 and 9 that the content of the compound represented by structural Formula 1 is too low, which has no obvious effect on improving the performance of the battery, and the high-temperature capacity retention rate of the battery is low. If the content of the compound represented by structural formula 1 is too high, the film would be too thick, which will lead to the increase of low-temperature impedance and the deterioration of low-temperature performance of the battery. From Comparative examples 10˜13, it can be seen that, if the mass of the single-sided negative electrode material layer (n) on the negative electrode per unit area or the specific surface area (a) of the negative electrode active material is too low, the compound represented by structural formula 1 would form a film on a limited reaction area, and the film thickness would be too large, which will affect the low-temperature performance of the battery. If the mass of the single-sided negative electrode material layer (n) on the negative electrode per unit area or the specific surface area (a) of the negative electrode active material is too high, the compound represented by structural formula 1 can not cover the surface of the negative electrode active material, and the side reaction of the non-aqueous electrolyte would increase, which will affect the high-temperature cycle performance of the battery and also leads to the deficiency of the low-temperature performance. The above indicates that the values of m, n and a has a strong correlation in improving the high and low temperature performance of lithium-ion batteries. Similarly, from Comparative examples 1-7, it can be seen that if the values of m, n and a fall within the range, while the value of m/(n*a) does not meet the above preset conditions, the improvement of battery performance is not obvious.

(2) Test results obtained from Embodiment 11 and Comparative examples 22-26 are shown in Table 4.

TABLE 4

| | Discharge capacity | |
|---|---|---|
| | retention rate | Capacity retention rate after |
| Group | (−20° C.)/% | 24 hours storage at 85° C./% |
| Embodiment 11 | 85.2 | 93.1 |
| Embodiment 22 | 84.1 | 93.2 |
| Embodiment 23 | 83.8 | 92.3 |
| Embodiment 24 | 84.4 | 93.0 |
| Embodiment 25 | 84.3 | 92.4 |
| Embodiment 26 | 84.9 | 92.5 |

According to the test results of Embodiment 11 and Embodiment 22-26, for different compounds represented by structural formula 1, when the percentage mass content (m) of the compound represented by structural formula 1 in the non-aqueous electrolyte, the mass of the single-sided negative electrode material layer (n) on the negative electrode per unit area and the specific surface area (a) of the negative electrode active material meet the preset condition: 1.5≤m/(n*a)≤600, their functions are similar, and they all have better improvement effects on the low-temperature capacity retention rate and the high-temperature capacity retention rate of lithium ion batteries. This indicates that the relationship proposed by the present application is applicable to different compounds represented by structural formula 1.

(3) Test results obtained from Embodiment 11, Embodiment 27˜29 and Comparative example 14 are shown in Table 5.

TABLE 5

| | Discharge capacity | Capacity retention rate |
|---|---|---|
| | retention rate | after 24 hours storage |
| Group | (−20° C.)/% | at 85° C./% |
| Embodiment 11 | 85.2 | 93.1 |
| Embodiment 27 | 86.0 | 91.7 |
| Embodiment 28 | 87.2 | 88.7 |
| Embodiment 29 | 86.1 | 90.9 |
| Comparative example 14 | 51.6 | 81.9 |

According to the test results of Embodiment 11 and Embodiment 27˜29, when different types of carboxylic esters are used as non-aqueous organic solvents, and when the percentage mass content (m) of the compound represented by structural formula 1 in the non-aqueous electrolyte, the mass of the single-sided negative electrode material layer (n) on the negative electrode per unit area and the specific surface area (a) of the negative electrode active material meet the preset condition: 1.5≤m/(n*a)≤600, lithium ion batteries with excellent low-temperature performance and high-temperature performance can be obtained. This indicates that the battery system provided by the application is suitable for different carboxylic esters.

Meanwhile, it can be seen from the test results of Embodiment 11, Embodiment 27˜29 and Comparative example 14, that it is necessary to add carboxylic ester into the non-aqueous electrolyte for the battery system provided by the present application. When carboxylic ester is not present in the non-aqueous electrolyte, even if the value of m/(n*a) meets the above preset conditions, the low-temperature performance of lithium-ion batteries is still poor. This indicates that the management of the values of m, n and a in this application inhibits the decomposition of carboxylic ester to some extent, and the stable existence of carboxylic ester is beneficial to the improvement of low-temperature performance of the battery.

(4) Test results obtained from Embodiment 11 and Embodiment 30˜33 and Comparative example 14 are shown in Table 6.

TABLE 6

| | | Capacity retention rate |
|---|---|---|
| | Discharge capacity | after 24 hours storage at |
| Group | retention rate (−20° C.)/% | 85° C./% |
| Embodiment 11 | 85.2 | 93.1 |
| Embodiment 30 | 84.4 | 94.1 |
| Embodiment 31 | 85.3 | 94.5 |
| Embodiment 32 | 83.5 | 95.0 |
| Embodiment 33 | 83.1 | 95.4 |

According to the test results of Embodiment 11 and Embodiment 30˜33, for the battery system provided by the application, the extra addition of fluoroethylene carbonate (FEC), succinonitrile (SN), 1,3-propane sultone (PS) or 1,3,6-hexanetricarbonitrile (HTCN) can further improve the capacity retention rate of lithium-ion batteries after high-temperature storage. It indicates that the mechanism of improving the battery performance by other additives is different from that of the compound represented by structural formula 1, and they have complementary effects on the film formation, thus improving the quality of the interface film on the surface of the negative electrode material layer. In addition, it can be seen that when the additive is 1,3-propane sultone (PS) or 1,3,6-hexanetricarbonitrile (HTCN), the low-temperature performance of the lithium-ion battery is deteriorated to some extent. While when the additive is fluoroethylene carbonate (FEC) or succinonitrile (SN), the high-temperature performance of lithium-ion battery is improved, and the low-temperature performance of lithium-ion battery is also improved.

The above are merely the preferred embodiments of this application, and are not intended to limit the application. Any modification, equivalent substitution and improvement made within the spirit and principle of this application shall be included in the protection scope of this application.

1. A lithium-ion battery, comprising a positive electrode, a negative electrode and a non-aqueous electrolyte, wherein the positive electrode comprises a positive electrode material layer, the positive electrode material layer comprises a positive electrode active material containing a lithium cobalt oxide, the negative electrode comprises a negative electrode current collector and a negative electrode material layer formed on the negative electrode current collector, the negative electrode material layer comprises a negative electrode active material, the non-aqueous electrolyte comprises a non-aqueous organic solvent, a lithium salt and an additive, and the non-aqueous organic solvent comprises a carboxylic ester, and the additive comprises a compound represented by structural formula 1: 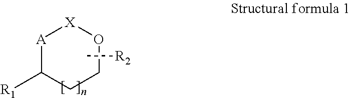
wherein n is 0 or 1, A is selected from C or O, X is selected from 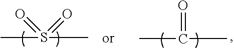
R₁ and R₂ are independently selected from H, 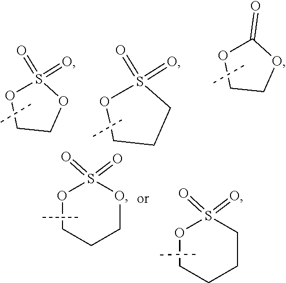
R₁ and R₂ are not selected from H at the same time, and X, R₁ and R₂ contain at least one sulfur atom;
the lithium-ion battery meets the following requirements:
1.5≤m/(n*a)≤600, and 0.05≤m≤5, 0.006≤n≤0.02, 0.6≤a≤2;
wherein m is a percentage mass content of the compound represented by structural formula 1 in the non-aqueous electrolyte, in %;
n is a mass of the single-sided negative electrode material layer on the negative electrode per unit area, in g/cm²; and
a is a specific surface area of the negative electrode active material, in m²/g.

2. The lithium-ion battery of claim 1, wherein the percentage mass content of the carboxylic ester is 10%-55% based on the total mass of the non-aqueous electrolyte.

3. The lithium-ion battery of claim 1, wherein the lithium-ion battery meets the following requirements:
5≤m/(n*a)≤300.

4. The lithium-ion battery of claim 1, wherein the percentage mass content (m) of the compound represented by structural formula 1 in the non-aqueous electrolyte is 0.1%-3%.

5. The lithium-ion battery of claim 1, wherein the mass of the single-sided negative electrode material layer (n) on the negative electrode per unit area is 0.008-0.015 g/cm².

6. The lithium-ion battery of claim 1, wherein the specific surface area (a) of the negative electrode active material is 0.7-1.6 m²/g.

7. The lithium-ion battery of claim 1, wherein the compound represented by structural formula 1 is selected from one or more of the following compounds:

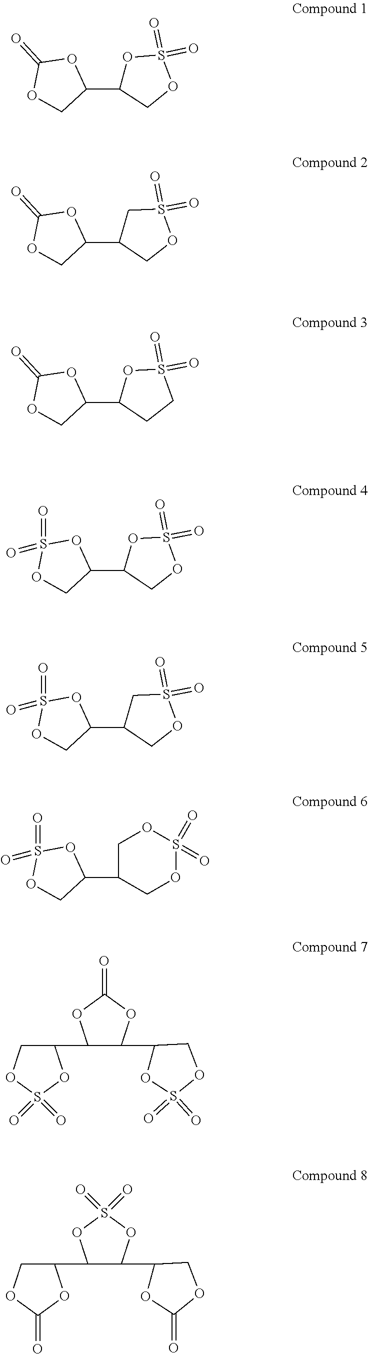

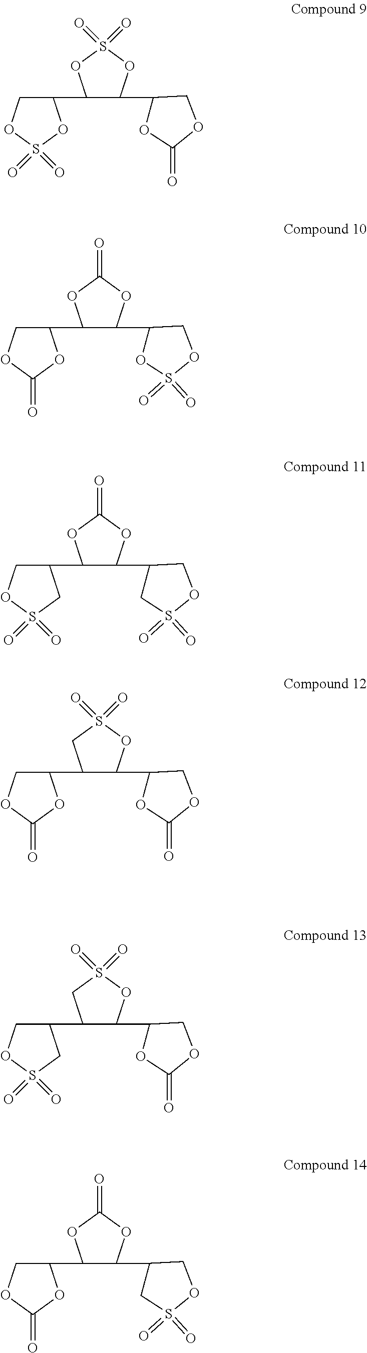 [SMILES: O=C1OCC(C2OS(=O)(=O)OC2C2COS(=O)(=O)O2)O1 ; O=C1OCC(C2OC(=O)OC2C2COS(=O)(=O)O2)O1 ; O=C1OC(C2COS(=O)(=O)C2)C(C2COS(=O)(=O)C2)O1 ; O=C1OCC(C2CS(=O)(=O)OC2C2COC(=O)O2)O1 ; O=C1OCC(C2OS(=O)(=O)CC2C2COS(=O)(=O)C2)O1 ; O=C1OCC(C2OC(=O)OC2C2COS(=O)(=O)C2)O1]

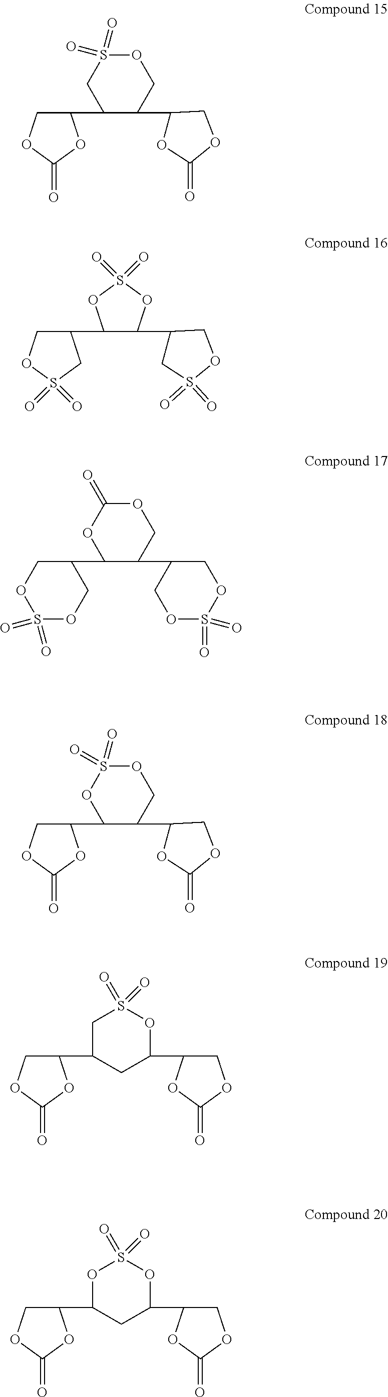 [SMILES: O=C1OCC(C2COS(=O)(=O)CC2C2COC(=O)O2)O1 ; O=S1(=O)CC(C2OS(=O)(=O)OC2C2COS(=O)(=O)C2)CO1 ; O=C1OCC(C2COS(=O)(=O)OC2)C(C2COS(=O)(=O)OC2)O1 ; O=C1OCC(C2COS(=O)(=O)OC2C2COC(=O)O2)O1 ; O=C1OCC(C2CC(C3COC(=O)O3)OS(=O)(=O)C2)O1 ; O=C1OCC(C2CC(C3COC(=O)O3)OS(=O)(=O)O2)O1]

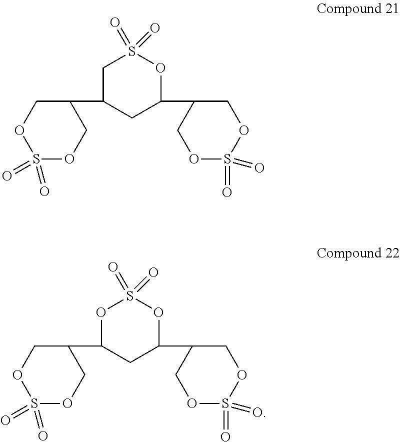 [SMILES: O=S1(=O)CC(C2COS(=O)(=O)OC2)CC(C2COS(=O)(=O)OC2)O1 ; O=S1(=O)OCC(C2CC(C3COS(=O)(=O)OC3)OS(=O)(=O)O2)CO1]

8. The lithium-ion battery of claim 1, wherein the carboxylic ester comprises a cyclic carboxylic ester and/or a chain carbonate.

9. The lithium-ion battery of claim 1, wherein the additive further comprises at least one of cyclic sulfate compounds, sultone compounds, cyclic carbonate compounds, phosphate compounds, borate compounds and nitrile compounds.

10. The lithium-ion battery of claim 9, wherein the content of the additive is 0.01%-30% based on the total mass of the non-aqueous electrolyte being 100%.

11. The lithium-ion battery of claim 9, wherein the cyclic sulfate compound is at least one selected from the group consisting of ethylene sulfate, propylene sulfate, methyl ethylene sulfate,

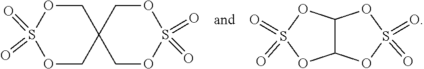 [SMILES: O=S1(=O)OCC2(CO1)COS(=O)(=O)OC2 ; O=S1(=O)OC2OS(=O)(=O)OC2O1]

12. The lithium-ion battery of claim 9, wherein the sultone compound is at least one selected from the group consisting of 1,3-propane sultone, 1,4-butane sultone and 1,3-propylene sultone.

13. The lithium-ion battery of claim 9, wherein the cyclic carbonate compound is selected from at least one of vinylene carbonate, vinylethylene carbonate, methylene ethylene carbonate, fluoroethylene carbonate, trifluoromethyl ethylene carbonate, bis-fluoroethylene carbonate or a compound represented by structural formula 2. 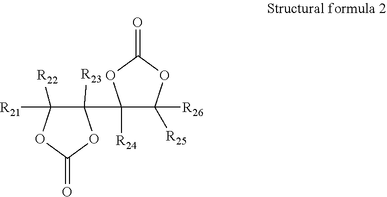
in structural formula 2, R₂₁, R₂₂, R₂₃, R₂₄, R₂₅ and R₂₆ are independently selected from one of a hydrogen atom, a halogen atom and a C1-C5 group.

14. The lithium-ion battery of claim 9, wherein the phosphate compound is selected from at least one of tri (trimethylsilane) phosphate, tri (trimethylsilane) phosphite or a compound represented by structural formula 3: 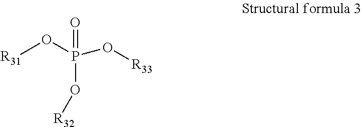
in structural formula 3, R₃₁, R₃₂ and R₃₃ are independently selected from a C1-C5 saturated hydrocarbon group, an unsaturated hydrocarbon group, a halogenated hydrocarbon group and —Si(CₘH₂ₘ₊₁)₃, m is a natural number of 1-3, and at least one of R₃₁, R₃₂ and R₃₃ is unsaturated hydrocarbon group.

15. The lithium-ion battery of claim 9, wherein the borate compound is selected from at least one of tris (trimethylsilane) borate and tris (triethyl silicane) borate.

16. The lithium-ion battery of claim 9, wherein the nitrile compound is selected from one or more of butanedinitrile, glutaronitrile, ethylene glycol bis (propionitrile) ether, hexanetricarbonitrile, adiponitrile, pimelic dinitrile, hexamethylene dicyanide, azelaic dinitrile and sebaconitrile.
